(19) United States
(12) Patent Application Publication
(10) Pub. No.: US 2026/0245528 A1
(43) Pub. Date: Aug. 20, 2026

(54) DISPLAY DEVICE AND METHOD OF ADJUSTING A STREAMING VIDEO

(71) Applicant: Realtek Semiconductor Corp., HsinChu (TW)

(72) Inventor: Chun-Yi Chen, HsinChu (TW)

(73) Assignee: Realtek Semiconductor Corp., HsinChu (TW)

(21) Appl. No.: 19/438,646

(22) Filed: Jan. 1, 2026

(30) Foreign Application Priority Data
Feb. 14, 2025 (TW) 114105461

(51) Int. Cl. G09G 5/00; G09G 5/26

(52) U.S. Cl. CPC G09G 5/005; G09G 5/26; G09G 2340/0435

(57) ABSTRACT

A display device for adjusting a streaming video includes a first display circuit configured with a first panel rate (PR); a detecting circuit, for detecting the first PR and a video frame rate (VFR) of the streaming video; a determination circuit, for determining a first frame number according to the VFR and the first PR in response to the VFR not being divisible by the first PR and the first PR not being divisible by the VFR; a computing circuit, for computing first motion vectors (MVs) of first frames in first group of pictures (GOPs) of the streaming video, and for selecting at least one first frame from the first frames according to the first MVs and the first frame number; and a processing circuit, for repeating or ignoring the at least one first frame in the first GOPs to generate second GOPs.

### BACKGROUND OF THE INVENTION

### 1. Field of the Invention

The present invention relates to a display device and a method, and more particularly, to a display device and a method for adjusting a streaming video.

### 2. Description of the Prior Art

As the complexity of current display devices increases, a frame rate of a streaming video may be different from a panel rate (PR) of a display device for playing the streaming video, or multiple display circuits in the display device may have different PRs. When the display device plays the streaming video, or when the streaming video moves from one display circuit to another, the streaming video may lag, causing a poor user experience. Thus, how to adjust the streaming video is an important problem to be solved.

### SUMMARY OF THE INVENTION

The present invention provides a display device and a method to solve the abovementioned problem.

A display device for adjusting a streaming video comprises: a first display circuit, configured with a first panel rate (PR); a detecting circuit, coupled to the first display circuit, for detecting the first PR and a video frame rate (VFR) of the streaming video; a determination circuit, coupled to the detecting circuit, for determining a first frame number according to the VFR and the first PR in response to the VFR not being divisible by the first PR and the first PR not being divisible by the VFR; a computing circuit, coupled to the determination circuit, for computing a plurality of first motion vectors (MVs) of a plurality of first frames in a plurality of first group of pictures (GOPs) of the streaming video, and for selecting at least one first frame from the plurality of first frames according to the plurality of first MVs and the first frame number; and a processing circuit, coupled to the computing circuit, for repeating or ignoring the at least one first frame in the plurality of first GOPs to generate a plurality of second GOPs.

A method for adjusting a streaming video comprises: detecting a first PR and a video frame rate (VFR) of the streaming video; determining a first frame number according to the VFR and the first PR in response to the VFR not being divisible by the first PR and the first PR not being divisible by the VFR; computing a plurality of first motion vectors (MVs) of a plurality of first frames in a plurality of first group of pictures (GOPs) of the streaming video, and selecting at least one first frame from the plurality of first frames according to the plurality of first MVs and the first frame number; and repeating or ignoring the at least one first frame in the plurality of first GOPs to generate a plurality of second GOPs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to an example of the present invention.

FIG. 2 is a schematic diagram of two display screens according to an example of the present invention.

FIG. 3 is a schematic diagram of two display screens according to an example of the present invention.

FIG. 4 is a schematic diagram of two display screens according to an example of the present invention.

FIG. 5 is a flowchart of a process according to an example of the present invention.

### DETAILED DESCRIPTION

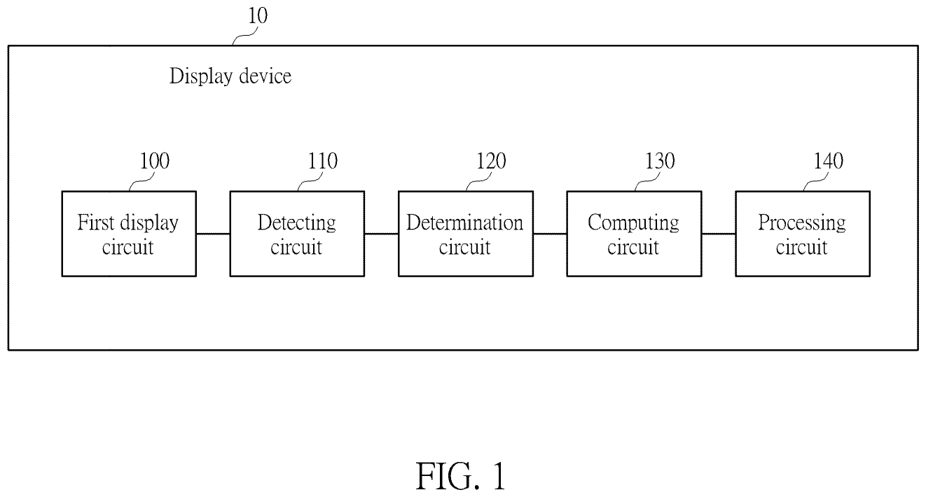

FIG. 1 is a schematic diagram of a display device 10 according to an example of the present invention. The display device 10 may be applied to scenarios such as car systems and games, but is not limited herein. The display device 10 comprises a first display circuit 100, a detecting circuit 110, a determination circuit 120, a computing circuit 130 and a processing circuit 140. In detail, the first display circuit 100 is configured with a first panel rate (PR). The detecting circuit 110 is coupled to the first display circuit 100, and is configured to detect the first PR and a video frame rate (VFR) of a streaming video. The determination circuit 120 is coupled to the detecting circuit 110, and is configured to determine a first frame number according to the VFR and the first PR in response to the VFR not being divisible by the first PR and the first PR not being divisible by the VFR. The computing circuit 130 is coupled to the determination circuit 120, is configured to compute a plurality of first motion vectors (MVs) of a plurality of first frames in a plurality of first group of pictures (GOPs) of the streaming video, and is configured to select at least one first frame from the plurality of first frames according to the plurality of first MVs and the first frame number. The processing circuit 140 is coupled to the computing circuit 130, and is configured to repeat or ignore the at least one first frame in the plurality of first GOPs to generate a plurality of second GOPs. In one example, the first display circuit 100 displays the streaming video according to the plurality of second GOPs.

In one example, the first frame number is a difference between the VFR and the first PR, in response to the VFR being greater than the first PR. In one example, the first frame number is a difference between the first PR and the VFR, in response to the first PR being greater than the VFR.

In one example, the plurality of first frames comprises at least one frame type. In one example, the at least one frame type comprises at least one of an intra-coded frame (I frame), a predicted frame (P frame) and a bi-predictive frame (B frame). In one example, each MV of the plurality of first MVs represents an image difference between a frame corresponding to the MV and a previous (or next) frame. In one example, a smaller value of the MV represents a smaller image difference.

In one example, the step of the computing circuit 130 selecting at least one first frame from the plurality of first frames according to the plurality of first MVs and the first frame number comprises: comparing a plurality of first values of the plurality of first MVs; selecting at least one first MV with a smallest value (or a relatively small value) from the plurality of first MVs, wherein a number of the at least one first MV is not greater than the first frame number; and selecting the at least one first frame corresponding to the at least one first MV from the plurality of first frames. In one example, a number of the at least one first frame is not greater than the first frame number. In one example, the B frame has a higher priority than the P frame and the I frame, when the computing circuit 130 selects the at least one first frame. That is, the computing circuit 130 preferentially selects the B frame.

In one example, the determination circuit 120 determines a first quotient according to the VFR and the first PR in response to the VFR being divisible by the first PR or the first PR being divisible by the VFR. In one example, the first quotient is a quotient of the VFR divided by the first PR in response to the VFR being divisible by the first PR. In one example, the first quotient is a quotient of the first PR divided by the VFR in response to the first PR being divisible by the VFR.

In one example, the display device 10 further comprises a first adjusting circuit (not shown in FIG. 1). The first adjusting circuit is coupled to the determination circuit, and is configured to adjust a first video output (VO) rate. In detail, the first adjusting circuit decreases the first VO rate according to the first quotient, in response to the VFR being divisible by the first PR, and increases the first VO rate according to the first quotient, in response to the first PR being divisible by the VFR. For example, when the determination circuit 120 determines the first quotient as N₁, the first VO rate adjusted by the first adjusting circuit is N₁ times or 1/N₁ times the original first VO rate.

In one example, the step of the processing circuit 140 repeating or ignoring the at least one first frame in the plurality of first GOPs to generate the plurality of second GOPs comprises: the processing circuit 140 repeats the at least one first frame in the plurality of first GOPs in response to the first PR being greater than the VFR. In one example, the step of the processing circuit 140 repeating or ignoring the at least one first frame in the plurality of first GOPs to generate the plurality of second GOPs comprises: the processing circuit 140 ignores the at least one first frame in the plurality of first GOPs in response to the VFR being greater than the first PR. In one example, a frame number of the plurality of second GOPs differs from a frame number of the plurality of first GOPs by the first frame number.

In one example, the display device 10 further comprises a second display circuit (not shown in FIG. 1). The second display circuit is coupled to the detecting circuit 110, and is configured with a second PR. In one example, the second PR is different from the first PR.

In one example, the detecting circuit 110 detects the first PR and the second PR. In one example, the determination circuit 120 determines a second frame number according to the first PR and the second PR in response to the first PR not being divisible by the second PR and the second PR not being divisible by the first PR. In one example, the computing circuit 130 computes a plurality of second MVs of a plurality of second frames in the plurality of second GOPs, and selects at least one second frame from the plurality of second frames according to the plurality of second MVs and the second frame number. In one example, the processing circuit 140 repeats or ignores the at least one second frame in the plurality of second GOPs to generate a plurality of third GOPs. In one example, the second display circuit displays the streaming video according to the plurality of third GOPs.

In one example, the second frame number is a difference between the first PR and the second PR in response to the first PR being greater than the second PR. In one example, the second frame number is a difference between the second PR and the first PR in response to the second PR being greater than the first PR.

In one example, the plurality of second frames comprises at least one frame type. In one example, the at least one frame type comprises at least one of an I frame, a P frame and a B frame. In one example, each MV of the plurality of second MVs represents an image difference between a frame corresponding to the MV and a previous (or next) frame. In one example, a smaller value of the MV represents a smaller image difference.

In one example, the step of the computing circuit 130 selecting at least one second frame from the plurality of second frames according to the plurality of second MVs and the second frame number comprises: comparing a plurality of second values of the plurality of second MVs; selecting at least one second MV with a smallest value (or a relatively small value) from the plurality of second MVs, wherein a number of the at least one second MV is not greater than the second frame number; and selecting the at least one second frame corresponding to the at least one second MV from the plurality of second frames. In one example, a number of the at least one second frame is not greater than the second frame number. In one example, the B frame has a higher priority than the P frame and the I frame, when the computing circuit 130 selects the at least one second frame. That is, the computing circuit 130 preferentially selects the B frame.

In one example, the determination circuit determines a second quotient according to the first PR and the second PR in response to the first PR being divisible by the second PR or the second PR being divisible by the first PR. In one example, the second quotient is a quotient of the first PR divided by the second PR in response to the first PR being divisible by the second PR. In one example, the second quotient is a quotient of the second PR divided by the first PR in response to the second PR being divisible by the first PR.

In one example, the first adjusting circuit decreases a second VO rate according to the second quotient in response to the first PR being divisible by the second PR, and increases the second VO rate according to the second quotient in response to the second PR being divisible by the first PR. For example, when the determination circuit 120 determines the first quotient as N₂, the second VO rate adjusted by the first adjusting circuit is N₂ times or 1/N₂ times the original second VO rate.

In one example, the step of the processing circuit 140 repeating or ignoring the at least one second frame in the plurality of second GOPs to generate the plurality of third GOPs comprises: the processing circuit 140 repeats the at least one second frame in the plurality of second GOPs in response to the second PR being greater than the first PR. In one example, the step of the processing circuit 140 repeating or ignoring the at least one second frame in the plurality of second GOPs to generate the plurality of third GOPs comprises: the processing circuit 140 ignores the at least one second frame in the plurality of second GOPs in response to the first PR being greater than the second PR. In one example, a frame number of the plurality of third GOPs differs from a frame number of the plurality of second GOPs by the first frame number.

In one example, the display device 10 further comprises a second adjusting circuit (not shown in FIG. 1). The second adjusting circuit is coupled to the first display circuit 100 and the second display circuit, is configured to determine a ratio according to a first parameter of the first display circuit 100 and a second parameter of the second display circuit, and is configured to adjust an image size of the streaming video according to the ratio. In one example, the first parameter and the second parameter are display areas of the first display circuit and the second display circuit, respectively. In one example, the first parameter and the second parameter are side lengths (or radii) of the display areas of the first display circuit and the second display circuit, respectively.

In one example, the display device 10 further comprises a third display circuit (not shown in FIG. 1). The third display circuit is coupled to the detecting circuit 110 (and the second adjusting circuit), and is configured with a third PR. In one example, the third PR is different from at least one of the first PR and the second PR. The examples for the third display circuit and the third PR can be known by referring to the previous examples for the second display circuit and the second PR, and are not narrated herein for brevity.

The following first example is used for illustrating how the display device 10 adjusts the streaming video. The streaming video comprises four GOPs GOP1-GOP4 (e.g., the plurality of first GOPs). Each GOP comprises six frames. In the GOPs GOP1-GOP4, the 1^{st} frame is the I frame “I”, the 2^{nd} frame is the P frame “P”, and the 3^{rd}-6^{th} frames are B frames “B”. The GOPs GOP1-GOP4 and the frames they comprise are shown in Table 1.

TABLE 1

| GOP | GOP1 | GOP2 | GOP3 | GOP4 |
|---|---|---|---|---|
| Original | I P BBBB | I P BBBB | I P BBBB | I P BBBB |
| frames | | | | |

First, the detecting circuit 110 detects the PR of the first display circuit 100 (e.g., the first PR) and the VFR of the streaming video. The PR is 30 frames per second (FPS), and the VFR is 24 FPS. Since the PR is greater than the VFR, the determination circuit 120 determines the frame number (e.g., the first frame number) as 6 (30−24=6). Then, the computing circuit 130 computes the MVs of all frames in the GOPs GOP1-GOP4 (e.g., the plurality of first MVs of the plurality of first frames). The computing circuit 130 selects four MVs with the smallest value (or relatively small values) by comparing the values of the MVs (e.g., sorting the values of the MVs from smallest to largest). The four selected MVs correspond to four frames in the GOPs GOP1-GOP4, respectively. The selected frames are shown as “ [symbol] ” in Table 2.

In the GOP GOP1, the processing circuit 140 repeats the selected frame “ [symbol] ” once to generate a new frame “ [symbol] ”. In the GOP GOP2, the processing circuit 140 repeats the selected frame “ [symbol] ” twice to generate two new frames “ [symbol] ”. In the GOP GOP3, the processing circuit 140 repeats the selected frame “ [symbol] ” once to generate a new frame “ [symbol] ”. In the GOP GOP4, the processing circuit 140 repeats the selected frame “ [symbol] ” twice to generate two new frames “ [symbol] ”. A total number of new frames is 6, which is the frame number determined by the determination circuit 120. Thus, the adjusted GOPs GOP1 and GOP3 comprise seven frames, and the adjusted GOPs GOP2 and GOP4 comprises eight frames (i.e., the VFR of the streaming video is adjusted to 30 FPS). Finally, the first display circuit 100 displays the streaming video according to the adjusted GOPs GOP1-GOP4 (e.g., the plurality of second GOPs).

TABLE 2

| GOP | GOP1 | GOP2 | GOP3 | GOP4 |
|---|---|---|---|---|
| Original | I P B [symbol] BB | I P B [symbol] BB | I P B [symbol] BB | I P B [symbol] BB |
| frames | | | | |
| Adjusted | I P B [symbol] BBB | I P B [symbol] BBBB | I P B [symbol] BBB | I P B [symbol] BBBB |
| frames | | | | |

The following second example is used for illustrating how the display device 10 adjusts the streaming video. Information of the streaming video can be known by referring to Table 1, and is not narrated herein for brevity. First, the detecting circuit 110 detects the PR of the first display circuit 100 (e.g., the first PR) and the VFR of the streaming video. The PR is 15 frames per second (FPS), and the VFR is 24 FPS. Since the VFR is greater than the PR, the determination circuit 120 determines the frame number (e.g., the first frame number) as 9 (24−15=9). Then, the computing circuit 130 computes the MVs of all frames in the GOPs GOP1-GOP4 (e.g., the plurality of first MVs of the plurality of first frames). The computing circuit 130 selects six MVs with the smallest value (or relatively small values) by comparing the values of the MVs (e.g., sorting the values of the MVs from smallest to largest). The six MVs correspond to the 4^{th}-5^{th} frames in the GOP GOP1, the 3^{rd}-5^{th} frames in the GOP GOP2, the 4^{th} and 6^{th} frames in the GOP GOP3, and the 4^{th}-5^{th} frames in the GOP GOP4. The selected frames are shown as “ [symbol] ” in Table 3.

In the GOPs GOP1-GOP4, the processing circuit 140 ignores the selected frames “ [symbol] ” to adjust the GOPs GOP1-GOP4. A total number of the ignored frame is 9, which is the frame number determined by the determination circuit 120. Thus, the adjusted GOPs GOP1, GOP3-GOP4 comprise four frames, and the adjusted GOP GOP2 comprises three frames (i.e., the VFR of the streaming video is adjusted to 15 FPS). Finally, the first display circuit 100 displays the streaming video according to the adjusted GOPs GOP1-GOP4 (e.g., the plurality of second GOPs).

TABLE 3

| GOP | GOP1 | GOP2 | GOP3 | GOP4 |
|---|---|---|---|---|
| Original | I P B [symbol] [symbol] B | I P [symbol] [symbol] [symbol] B | I P B [symbol] B [symbol] | I P B [symbol] [symbol] B |
| frames | | | | |
| Adjusted | I P BB | I P B | I P BB | I P BB |
| frames | | | | |

The following third example is used for illustrating how the display device 10 adjusts the streaming video. Information of the streaming video can be known by referring to Table 1, and is not narrated herein for brevity. First, the detecting circuit 110 detects the PR of the first display circuit 100 (e.g., the first PR) and the VFR of the streaming video. The PR is 60 frames per second (FPS), and the VFR is 24 FPS. According to the first example, the display device 10 adjusts the VFR of the streaming video to 30 FPS. Then, the determination circuit determines the quotient (e.g., the first quotient) as 2 (60÷30=2) according to the adjusted VFR and the PR. Since the PR is divisible by the adjusted VFR, the first adjusting circuit increases the VO rate (e.g., the first VO rate). The increased VO rate is twice the original VO rate. Finally, the first display circuit 100 displays the streaming video according to the increased VO rate.

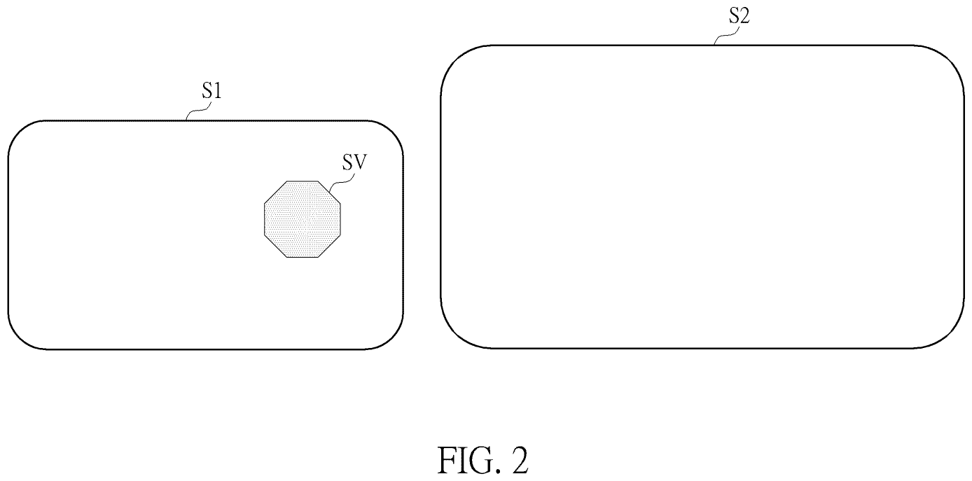

FIG. 2-4 are schematic diagrams of two display screens S1-S2 (e.g., the first display circuit 100 and the second display circuit) according to an example of the present invention, and are used for illustrating how the display device 10 adjusts the streaming video. The display screens S1-S2 are in the display device 10, and have different display areas. The PR of the display screen S1 is 30 FPS, and the PR of the display screen S2 is 60 FPS. The display screens S1-S2 each comprise eight display units DU1-DU8.

In FIG. 2, the display screen S1 displays the streaming video SV. The statuses of the display units DU1-DU8 of the screens S1-S2 can be known by referring to Table 4. “•” represents that the display unit of the screen S1 displays the streaming video SV.

TABLE 4

| | | | | | | | |
|---|---|---|---|---|---|---|---|
| DU1 | DU2 | DU3 | DU4 | DU5 | DU6 | DU7 | DU8 |

| | | |
|---|---|---|
| S1 | • | • |
| S2 | | |

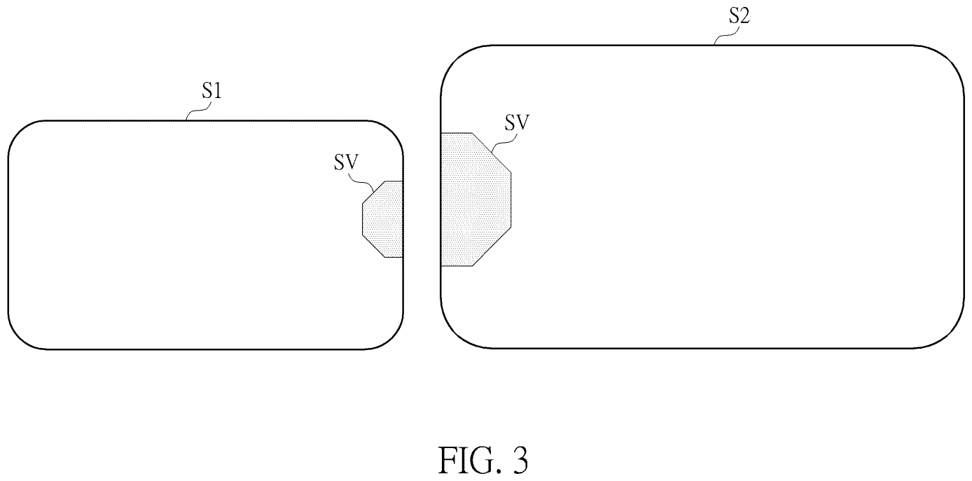

The streaming video SV moves toward the screen S2, as shown in FIG. 3. The screens S1-S2 display a portion of the streaming video SV. The statuses of the display units DU1-DU8 of the screens S1-S2 can be known by referring to Table 5. “•” represents that the display unit of the screen S1 displays the streaming video SV, and represents that the display unit of the screen S2 displays the streaming video SV.

TABLE 5

| | DU1 | DU2 | DU3 | DU4 | DU5 | DU6 | DU7 | DU8 |
|---|---|---|---|---|---|---|---|---|
| S1 | | | | | | | | • |
| S2 | ⊚ | | | | | | | |

It should be noted that, since the display area P2 of the display screen S2 is greater than the display area P1 of the display screen S1, the second adjusting circuit determines the ratio (e.g., P2/P1) and magnifies the image size of the streaming video SV according to the ratio. In addition, since the PRs of the display screens S1-S2 are different, the display device 10 adjusts the VFR or the VO rate of the streaming video SV (e.g., increases the VO rate, wherein the increased VO rate is twice the original VO rate (60÷30=2)) when the streaming video SV moves toward the screen S2.

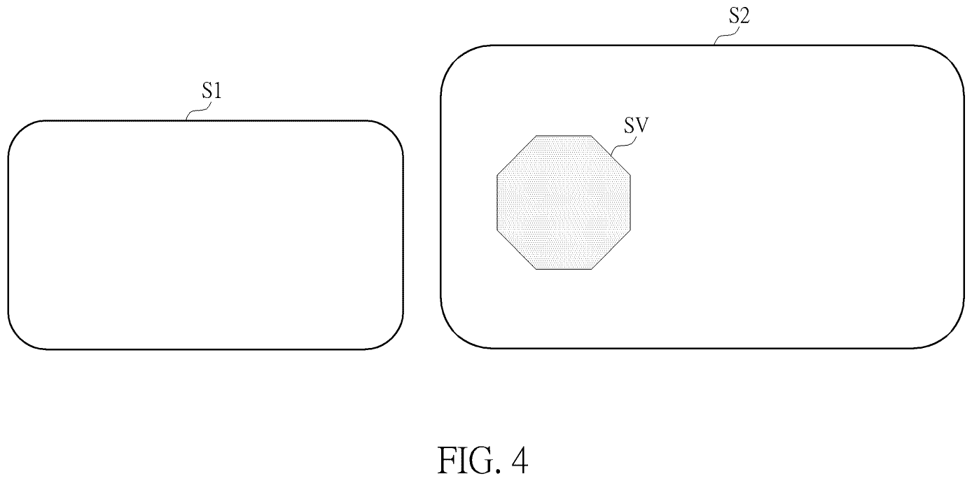

The streaming video SV is completely moved from the display screen S1 to the display screen S2, as shown in FIG. 4. The display screen S2 displays the streaming video SV according to the increased VO rate. The statuses of the display units DU1-DU8 of the screens S1-S2 can be known by referring to Table 6. “⊚” represents that the display unit of the screen S2 displays the streaming video SV.

TABLE 6

| | DU1 | DU2 | DU3 | DU4 | DU5 | DU6 | DU7 | DU8 |
|---|---|---|---|---|---|---|---|---|
| S1 | | | | | | | | |
| S2 | | ⊚ | ⊚ | | | | | |

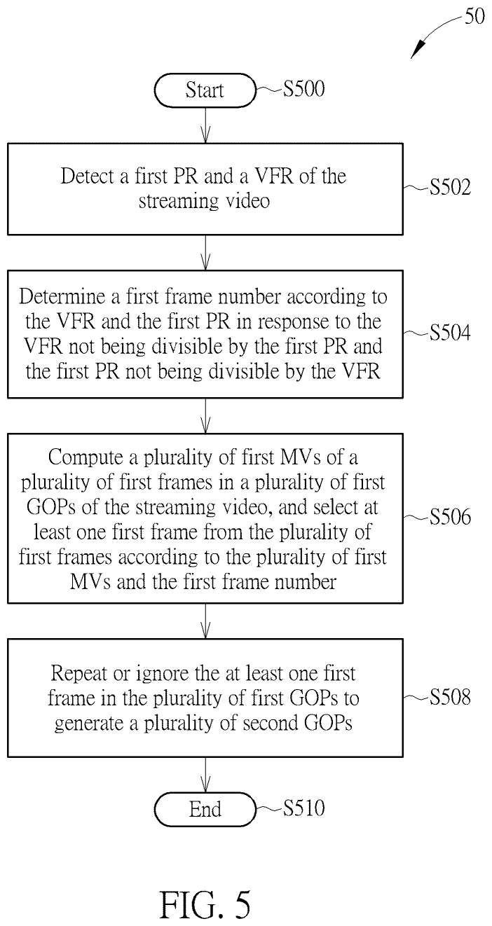

Operations of the display device 10 in the above examples can be summarized into a process 50 shown in FIG. 5, which includes the following steps:
Step S500: Start.
Step S502: Detect a first PR and a VFR of the streaming video.
Step S504: Determine a first frame number according to the VFR and the first PR in response to the VFR not being divisible by the first PR and the first PR not being divisible by the VFR.
Step S506: Compute a plurality of first MVs of a plurality of first frames in a plurality of first GOPs of the streaming video, and select at least one first frame from the plurality of first frames according to the plurality of first MVs and the first frame number.
Step S508: Repeat or ignore the at least one first frame in the plurality of first GOPs to generate a plurality of second GOPs.
Step S510: End.

The process 50 is used for illustrating the operations of the display device 10. A detailed description and variations of the process 50 can be understood by those skilled in the art by referring to the above description, and are not narrated herein.

It should be noted that there are various possible realizations of the display device 10. For example, the devices (circuits) mentioned above may be integrated into one or more devices (circuits). In addition, the display device 10 may be realized by hardware (e.g., circuits), software, firmware (known as a combination of a hardware device, computer instructions and data that reside as read-only software on the hardware device), an electronic system or a combination of the devices mentioned above, but are not limited herein.

The operation of “determine” described above may be replaced by the operation of “compute”, “calculate”, “obtain”, “generate”, “output, “use”, “choose/select”, “decide” or “is configured to”. The operation of “detect” described above may be replaced by the operation of “monitor”, “receive”, “sense” or “obtain”. The phrase “according to” described above may be replaced by “in response to”. The term “corresponding to” described above may be replaced by “of” or “associated with”. The term “via” described above may be replaced by “on”, “in” or “at”. The term “comprise” described above may be replaced by “is/are”. The term “when” described above may be replaced by “in response to”.

To sum up, the present invention provides a display device and a method for adjusting a streaming video. The display device adjusts the frame number of the GOPs of the streaming video (e.g., repeats or ignores some frames in the GOPs) and/or adjusts (e.g., increases or decreases) the VO rate, to avoid the issue of lag. In addition, when multiple display circuits have different parameters (e.g., different display areas), the display device adjusts the image size of the streaming video according to the ratio of these parameters. Thus, the problem of how to adjust the streaming video can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device for adjusting a streaming video, comprising:
a first display circuit, configured with a first panel rate (PR);
a detecting circuit, coupled to the first display circuit, for detecting the first PR and a video frame rate (VFR) of the streaming video;
a determination circuit, coupled to the detecting circuit, for determining a first frame number according to the VFR and the first PR in response to the VFR not being divisible by the first PR and the first PR not being divisible by the VFR;
a computing circuit, coupled to the determination circuit, for computing a plurality of first motion vectors (MVs) of a plurality of first frames in a plurality of first group of pictures (GOPs) of the streaming video, and for selecting at least one first frame from the plurality of first frames according to the plurality of first MVs and the first frame number; and
a processing circuit, coupled to the computing circuit, for repeating or ignoring the at least one first frame in the plurality of first GOPs to generate a plurality of second GOPs.

2. The display device of claim 1, wherein the first display circuit displays the streaming video according to the plurality of second GOPs.

3. The display device of claim 1, wherein the first frame number is a difference between the VFR and the first PR in response to the VFR being greater than the first PR.

4. The display device of claim 1, wherein the first frame number is a difference between the first PR and the VFR in response to the first PR being greater than the VFR.

5. The display device of claim 1, wherein the determination circuit determines a first quotient according to the VFR and the first PR in response to the VFR being divisible by the first PR or the first PR being divisible by the VER.

6. The display device of claim 5, further comprising:
a first adjusting circuit, coupled to the determination circuit, for:
decreasing a first video output (VO) rate according to the first quotient in response to the VFR being divisible by the first PR; and
increasing the first VO rate according to the first quotient in response to the first PR being divisible by the VFR.

7. The display device of claim 1, wherein the processing circuit repeats the at least one first frame in the plurality of first GOPs in response to the first PR being greater than the VFR.

8. The display device of claim 1, wherein the processing circuit ignores the at least one first frame in the plurality of first GOPs in response to the VFR being greater than the first PR.

9. The display device of claim 1, further comprising:
a second display circuit, coupled to the detecting circuit and configured with a second PR;
wherein the second PR is different from the first PR.

10. The display device of claim 9, wherein:
the detecting circuit detects the first PR and the second PR;
the determination circuit determines a second frame number according to the first PR and the second PR in response to the first PR not being divisible by the second PR and the second PR not being divisible by the first PR;
the computing circuit computes a plurality of second MVs of a plurality of second frames in the plurality of second GOPs, and selects at least one second frame from the plurality of second frames according to the plurality of second MVs and the second frame number; and
the processing circuit repeats or ignores the at least one second frame in the plurality of second GOPs to generate a plurality of third GOPs.

11. The display device of claim 10, wherein the second display circuit displays the streaming video according to the plurality of third GOPs.

12. The display device of claim 9, wherein the determination circuit determines a second quotient according to the first PR and the second PR in response to the first PR being divisible by the second PR or the second PR being divisible by the first PR.

13. The display device of claim 12, further comprising:
a first adjusting circuit, coupled to the determination circuit, for:
decreasing a second VO rate according to the second quotient in response to the first PR being divisible by the second PR; and
increasing the second VO rate according to the second quotient in response to the second PR being divisible by the first PR.

14. The display device of claim 9, further comprising:
a second adjusting circuit, coupled to the first display circuit and the second display circuit, for determining a ratio according to a first parameter of the first display circuit and a second parameter of the second display circuit and for adjusting an image size of the streaming video according to the ratio.

15. A method for adjusting a streaming video, comprising:
detecting a first PR and a video frame rate (VFR) of the streaming video;
determining a first frame number according to the VFR and the first PR in response to the VFR not being divisible by the first PR and the first PR not being divisible by the VFR;
computing a plurality of first motion vectors (MVs) of a plurality of first frames in a plurality of first group of pictures (GOPs) of the streaming video, and selecting at least one first frame from the plurality of first frames according to the plurality of first MVs and the first frame number; and
repeating or ignoring the at least one first frame in the plurality of first GOPs to generate a plurality of second GOPs.

16. The method of claim 15, wherein the first frame number is a difference between the VFR and the first PR in response to the VFR being greater than the first PR.

17. The method of claim 15, wherein the first frame number is a difference between the first PR and the VFR in response to the first PR being greater than the VFR.

18. The method of claim 15, further comprising:
determining a first quotient according to the VFR and the first PR in response to the VFR being divisible by the first PR or the first PR being divisible by the VFR.

19. The display device of claim 15, wherein the at least one first frame is repeated in the plurality of first GOPs in response to the first PR being greater than the VFR.

20. The display device of claim 15, wherein the at least one first frame is ignored in the plurality of first GOPs in response to the VFR being greater than the first PR.
